(19) United States
(12) Patent Application Publication
(10) Pub. No.: US 2012/0254972 A1
(43) Pub. Date: Oct. 4, 2012

(54) TRUST SYSTEM

(75) Inventor: Mike S. Fulton, Maple Ridge (CA)

(73) Assignee: INTERNATIONAL BUSINESS MACHINES CORPORATION, Armonk, NY (US)

(21) Appl. No.: 13/079,211

(22) Filed: Apr. 4, 2011

(51) Int. Cl. H04L 9/32

(52) U.S. Cl. 726/9

(57) ABSTRACT

An illustrative embodiment of a computer-implemented process for delegating access to private data receives a request at a trusted server, forwards the received request to an untrusted third party application and invokes a transaction on a secure data store. The computer-implemented process further tokenizes data received from the secure data store by the trusted server, returns the tokenized data to the untrusted third party application, modifies the tokenized data by the untrusted third party application, requests the trusted server to send results to a requester and sends the results from the trusted server to the requester for display.

### BACKGROUND

1. Technical Field

This disclosure relates generally to data security in a data processing system and more specifically to delegating all access to private data to an owning secure server of the private data using a trust system in the data processing system.

2. Description of the Related Art

Potential software applications are typically not provided currently because users are unable to trust the applications. For example, a web-based application receiving input in the form of financial transactions associated with a user for a period of time performs a set of operations on the data, perhaps to categorize the data, and displays a result to the user.

While this type of application is typically very useful, a potential user is unwilling to use the application because the user does not trust the application. Uploaded private financial data by the application is not to be shared, or possibly compromised by the application in some way, but the user does not trust the application. Solutions for encrypting the data to prevent a third party application from obtaining access to private data exist but there is little to protect a possible user from a malicious, or perhaps poorly written, application that decrypts and mishandles data (for example, writing the data to a disk that is subsequently stolen or leaving the data in a storage location which is viewed or reused by another application).

Typical security consideration focus on whether a user has proper credentials to access data. For example whether a client has access to a function for computing using a trusted third party, or using a trusted device to verify information received from a trusted component, or whether a delegated device or operation is permitted to perform an operation on behalf of a delegator, a requesting user. In another example, individuals may delegate information retrieval to a trusted third party, but when control is delegated to multiple trusted third parties, all parties must consent.

Access control programs are typically designed to keep untrusted entities from processing information, which therefore may preclude use of potentially useful applications. There is, however, a need for use of potentially useful applications provided by untrusted entities.

### SUMMARY

According to one embodiment, a computer-implemented process for delegating access to private data receives a request at a trusted server, forwards the received request to an untrusted third party application and invokes a transaction on a secure data store. The computer-implemented process further tokenizes data received from the secure data store by the trusted server, returns the tokenized data to the untrusted third party application, modifies the tokenized data by the untrusted third party application, requests the trusted server to send results to a requester and sends the results from the trusted server to the requester for display.

According to another embodiment, a computer program product for delegating access to private data comprises a computer recordable-type media containing computer executable program code stored thereon. The computer executable program code comprises computer executable program code for receiving a request at a trusted server, computer executable program code for forwarding the received request to an untrusted third party application, computer executable program code for invoking a transaction on a secure data store, computer executable program code for tokenizing data received from the secure data store by the trusted server, computer executable program code for returning the tokenized data to the untrusted third party application, computer executable program code for modifying the tokenized data by the untrusted third party application, computer executable program code for requesting the trusted server to send results to a requester and computer executable program code for sending the results from the trusted server to the requester for display.

According to another embodiment, an apparatus for delegating access to private data comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive a request at a trusted server, forward the received request to an untrusted third party application, invoke a transaction on a secure data store, tokenize data received from the secure data store by the trusted server, return the tokenized data to the untrusted third party application, modify the tokenized data by the untrusted third party application, request the trusted server to send results to a requester and send the results from the trusted server to the requester for display.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system network operable for various embodiments of the disclosure;

FIG. 2 is a block diagram of an exemplary data processing system operable for various embodiments of the disclosure;

FIG. 3 is a block diagram of components of a trust system, in accordance with one embodiment of the disclosure;

FIG. 4 is a block diagram of a high level data flow in the trust system of FIG. 3, in accordance with one embodiment of the disclosure;

FIG. 5 is a flowchart of a process using the trust system of FIG. 3, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc. or any suitable combination of the foregoing.

Computer program code for carrying out operations for aspects of the present disclosure may be written in any combination of one or more programming languages, including an object oriented programming language such as Java®, Smalltalk, C++, or the like and conventional procedural programming languages, such as the “C” programming language or similar programming languages. Java is a registered trademark and all Java-based trademarks and logos are trademarks of Oracle, and/or its affiliates, in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

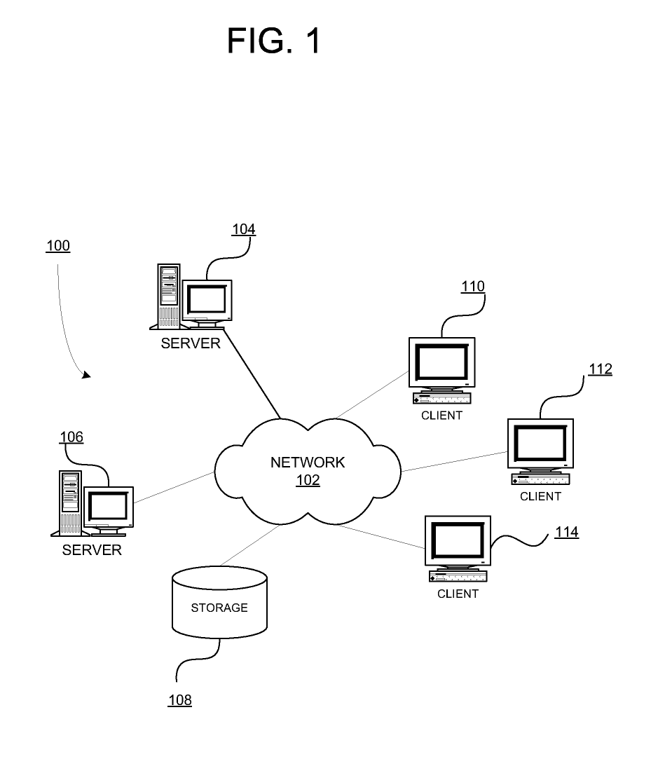

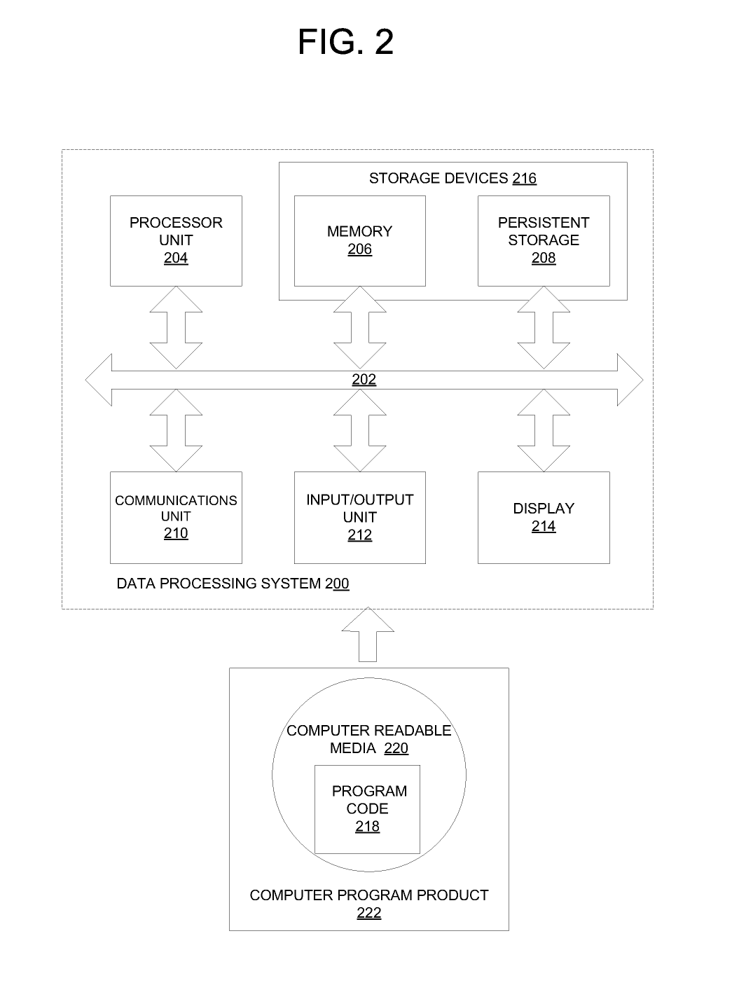

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference to FIG. 2 a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

Using data processing system 200 of FIG. 2 as an example, a computer-implemented process for delegating access to private data is presented. Processor unit 204 receives a request at a trusted server, typically using communications unit 210, input/output unit 212 or storage devices 216. Processor unit 204 forwards the received request to an untrusted third party application and invokes a transaction on a secure data store of storage devices 216. Processor unit 204 further tokenizes data received from the secure data store by the trusted server, returns the tokenized data to the untrusted third party application, modifies the tokenized data by the untrusted third party application. Processor unit 204 requests the trusted server to send results to a requester and sends the results from the trusted server to the requester for display using communications unit 210. Processor unit 204 is capable of sending over a network such as network 102 to client 114 both of data processing system 100 of FIG. 1.

In another example, a computer-implemented process, using program code 218 stored in memory 206 or as a computer program product 222, for delegating access to private data comprises a computer recordable storage media, such as computer readable media 220, containing computer executable program code stored thereon. The computer executable program code comprises computer executable program code for delegating access to private data.

In another illustrative embodiment, the process for delegating access to private data may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to delegate access to private data.

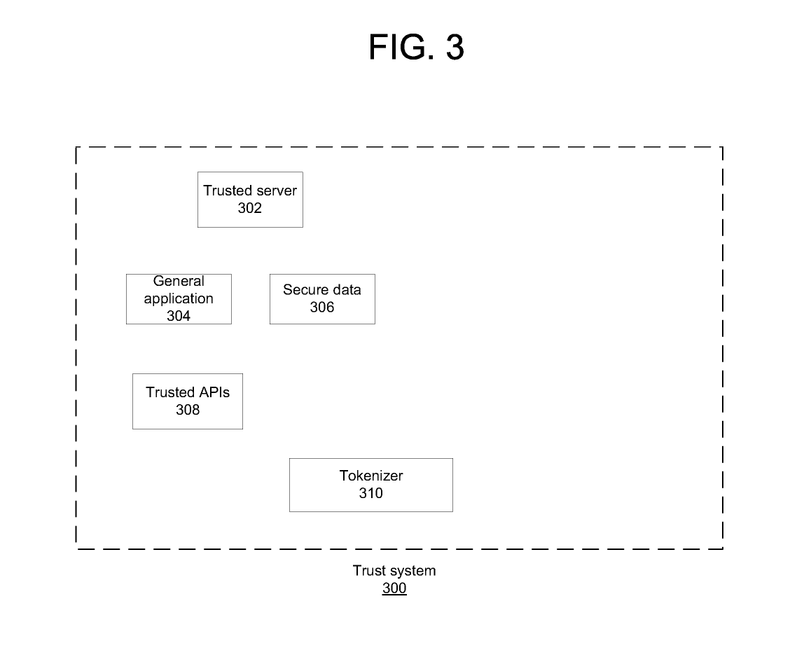

With reference to FIG. 3, a block diagram of components of a trust system, in accordance with one embodiment of the disclosure is presented. Trust system 300 is an example of a combination of components enabling an untrusted application to communicate with a trusted server to work with the secure data while ensuring the untrusted application does not see contents of secure data and leveraging resources of a data processing system, such as data processing system 200 of FIG. 2.

Trust system 300 comprises a number of components including trusted server 302, general application 304, secure data 306, trusted APIs 308 and tokenizer 310. Although shown as a combination of separate components, trust system 300 may also be implemented as a monolithic embodiment comprising functions, which operate as logically separate components.

Trusted server 302 provides a capability to interface with secure data 306 to process user requests for information in a trusted environment. Trusted server 302 further comprises application-programming interfaces for use by general application 304. General application 304 is an untrusted application that is defined to be outside the trusted environment of trusted server 302 and secure data 304.

General application 306 uses trusted APIs 308 to communicate with trusted server 302 while handling user requests. Trusted APIs 308 enables general application 306 to process data and communicate with trusted server 302 while not permitted to see contents of any secure data. General application 306 only has access to ‘handles’ representing the data that the application can store. Tokenizer 310 transforms all secure data returned from secure data 306 into respective tokens that are sent to general application 304. All operations on the data (arithmetic, comparison, display) are performed through trusted server 302, using tokens separating application logic from data manipulation.

Trusted server 302 can be either local or remote to a user or general application 304, but would still be a trusted server of the secure data. The combination of tokenized data and trusted application programming interfaces ensures data processed by general application 304 is not seen by the application and therefore remains secure data.

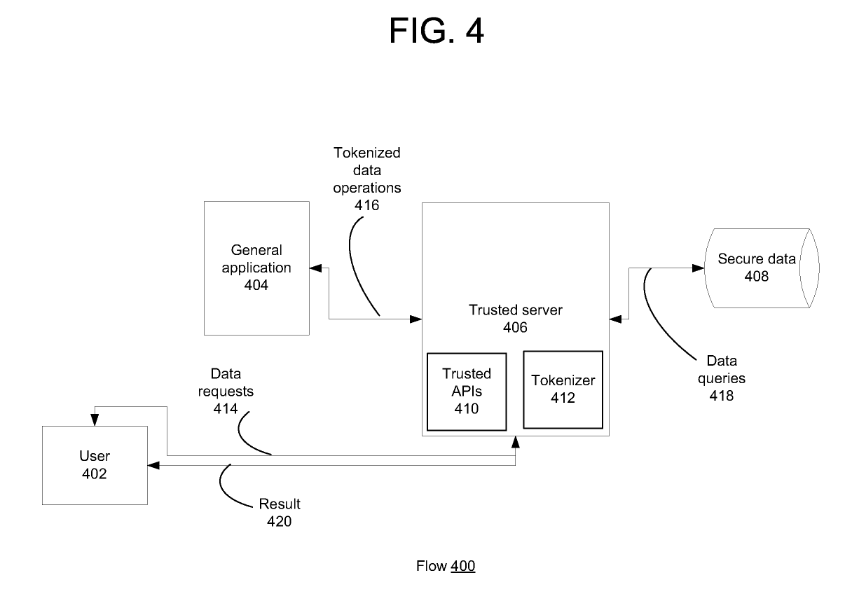

With reference to FIG. 4, a block diagram of data flow of a trust system, in accordance with one embodiment of the disclosure is presented. Flow 400 is an example of a high-level data flow within a trust system such as trust system 300 of FIG. 3.

User 402 initiates a request for information in the form of data requests 414 from trusted server 406. As stated previously the general application is not part of a trusted environment comprising trusted server 406 and secure data 408. When user 402 submits a request and communicates with trusted server 406, user 402 may submit an identifier with an initial request or with each request for authentication to trusted server 406. The submitted identifier may be used by general application 404 during correspondence with trusted server 406.

General application 404 processes requests and data delegated by trusted server 406 for user 402 using a flow of tokenized data operations 416. Communication between general application 404 and trusted server 406 is performed using trusted APIs 410 made available by trusted server 406. Trusted APIs 410 may also be pushed out to general application 404 as required by an implementation.

Tokenizer 412 of trusted server 406 transforms data sent from general application 404 to secure data 408 and received from secure data 408 using data queries 418.

In one example of a financial transaction application represented by general application 404, a bank represented by trusted server 406 holds financial data and provides secure transaction services, ensuring that the application does not obtain decrypted data, but can request operations on the data. The flow of control for this form of application could be as shown in an illustrative embodiment of flow 400. A user such as user 402 views the bank site, securely logs in to the site represented by trusted server 406 and requests trusted server 406 launch a financial categorization application (FCA) represented by general application 404, developed by an untrusted software company Jokers Wild Computing. The bank site launches the financial categorization application. The financial categorization application requests field descriptions in a transaction record (the bank in response returns: date/account #/description/amount retrieved from secure data 408). The financial categorization application requests a set of categories in which the transactions should be organized (the bank tokenizes data retrieved from secure data 408 and returns a handle, the token, to a category set). For each encrypted category the financial categorization application obtains an encrypted category pattern handle ‘i’ from the bank. The financial categorization application obtains handles for each description/amount pair and in turn queries the bank as to whether the encrypted category pattern is in the description and/or amount (*). When a determination is made that the encrypted category pattern is in the description and/or amount (*), then the particular entry is categorized as category ‘i’.

General text comparison operations for (*) are performed by trusted server 406. For example, a category description specified as ‘restaurant’ with a pattern of ‘McDonalds’ (all encrypted) enables general pattern matching routines such as ‘return true when the associated pattern handle is in the respective description handle’. General application 404 therefore never actually sees the raw data for the category or the description.

Once general application 404 has organized data as appropriate, general application 404 sends a request (or set of requests) to the bank server, trusted server 406, indicating a format to display the data to user 402. The simplest format of display formatting would be a raw text display of the data with the category added, but more sophisticated interfaces are developed for a better user experience. The bank server, trusted server 406, is responsible for displaying real data to user 402 and not general application 404.

In an alternative embodiment user 402 initiates a request for information in the form of data requests 414 from general application 404. As before the general application is not part of a trusted environment comprising trusted server 406 and secure data 408. When user 402 submits a request and communicates with general application 406 user 402 may submit an identifier with an initial request or with each request for authentication to trusted server 406. The submitted identifier may be used by general application 404 during correspondence with trusted server 406. The requester, user 402, would perceive all transactions as being processed on trusted server 406 as in the previous illustrative embodiment.

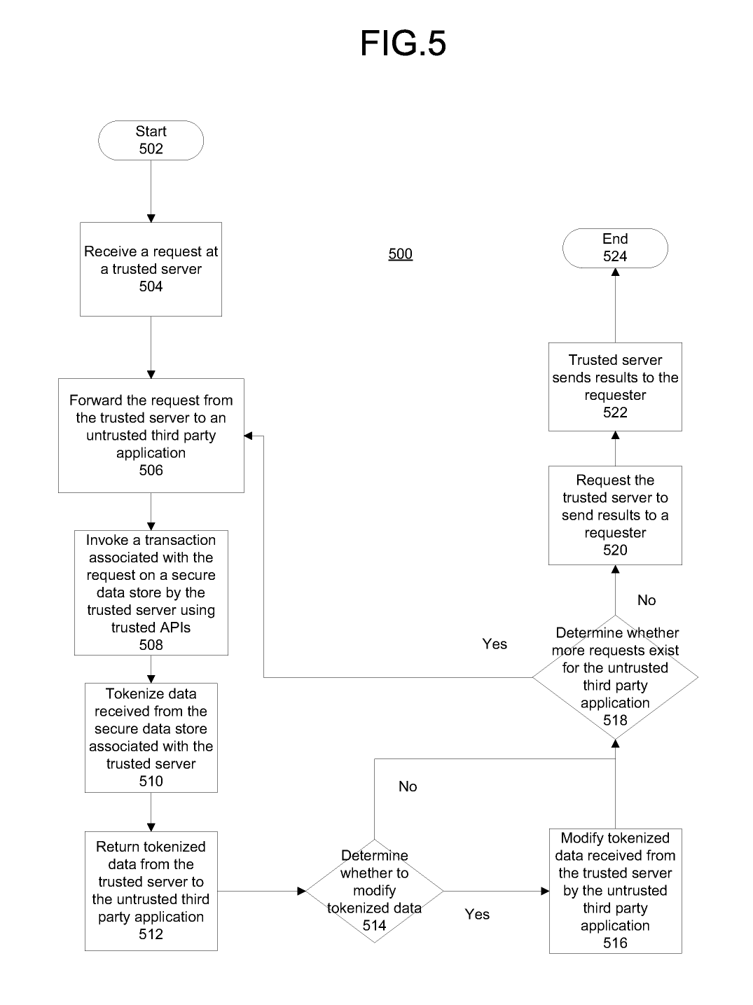

FIG. 5 is a flowchart of a process using the trust system of FIG. 3, in accordance with one embodiment of the disclosure. Process 500 is an example of a process providing a capability to delegate all access to private data back to the owning secure server of the private data using trust system 300 of FIG. 3.

A potential downside of using process 500 may be a significant number of requests to/from the trusted server from the general application for comparison of data, performing arithmetic operations on numbers, and final display of data. However, in typical cases, such as the financial application described in the example of FIG. 4, much of the data can be processed in parallel and batch network requests can be created to optimize network transmissions. Parallel processing and batching of network transmissions is suited for large multicore systems capable of processing a set of fields in parallel (for categorization), and sending a set of requests for comparison operations over the network at once, instead of one at a time. Process 500 of FIG. 5 provides a more detailed explanation of services provided by trust system 300 of FIG. 3 to the potentially unsecure third party application and the process by which the services are used.

Process 500 begins (step 502) and receives a request at trusted server (step 504). Process 500 forwards the request from the trusted server to an untrusted third party application from the trusted server (step 506). The forwarding action is a result of the trusted server delegating the request from the user to the untrusted third party application. Continuing to use the example of a banking application that categorizes expenses of a user and displays results, a set of input services is provided by the trusted server accessible to the untrusted third party application through a set of trusted APIs. These services enable a customer to enter information stored on the data server as secure data and accessible by the untrusted third party application through an opaque handle or token.

Process 500 invokes a transaction associated with the request on a secure data store by the trusted server using trusted APIs (step 508). For example, the untrusted third party application requests a user-provided constant for the untrusted third party application (the untrusted third party application requests a new category the customer requires for associated finances). An exemplary interface could be: handle=requestStringConstant(“label”, “hover help”, oldHandle) where label is a label to display, hover help is hover help to display, and oldHandle is a previously entered handle (may also be a null value).

Similar input interfaces would be provided for other data types including Date, and Number. Input interfaces are provided for multiple entry selection as well, returning a handle, which is an array of entries.

Each core object type (Boolean, string, date, number (which would consist of real and integer sub-types)) provides a compareTo service, enabling the untrusted third party application to perform a comparison of opaque handles. For example, two string objects could be compared as result=stringHandleA.compareTo(stringHandleB). Result is a comparison object with methods equals, lessThan, and greaterThan returning corresponding Boolean results. There are also three methods defined for all objects that have trivial implementations for shorthand (equals, lessThan and greaterThan), which return a Boolean result, for example, stringHandleA.lessThan(stringHandleB) returns a Boolean and is implemented as boolean lessThan(Object other) {return this.compareTo(other).lessThan( );}.

A comparison can only be performed against handles therefore preventing the untrusted third party application from determining a value of any object, permitting determining only how an object compares to other objects. Were the untrusted third party application able to compare to known constants (for example, 0 or Jan. 1, 2010), then untrusted third party application could deduce information regarding a value of the data.

To obtain data to process, the untrusted third party application performs general queries against the trusted server. These queries are sector, or perhaps even application, specific. In the example, the trusted server provides query services to extract information about the transactions, for example, startDate=requestDateConstant(“start date”, . . . ); endDate=requestDateConstant(“end date”, . . . ); dataArray=performQuery(“select date, description, amount from chequing”). The specific performQuery( ) operation creates an array of opaque objects. The size of the array is not known to the untrusted third party application, only the trusted server. Each object in the array has a date, description and amount field (as defined by the server-specific query service).

In addition to string, date, and number, arrays and hash maps (sometimes called hashes) are provided for grouping a collection of objects. All collections implement iterate, add, and remove methods. The untrusted third party application programmer can create application specific aggregate types, with application specific methods and, in particular, can provide an application specific compareTo method. The untrusted third party application programmer can create an application specific collection, but must implement iterate, add, and remove methods.

Process 500 tokenizes data received on the secure server from the secure data store associated with the trusted server (step 510). Process 500 returns the tokenized data from the trusted server to the untrusted third party (step 512). A determination is made as to whether to modify the tokenized data (step 514).

Responsive to a determination that the tokenized data is to be modified, modify tokenized data received from the trusted server by the untrusted third party application is performed (step 516). Object manipulation services are used to modify the tokenized data received from the trusted server.

For example, modification includes objects in which fields are added or removed. Objects can also be queried to determine fields currently in the object (reflection). Closures are supported as a convenient way to perform an action across a collection (array or hash map). Closure methods provide the notion of a closure scope, enabling an application developer to retain state information for elements as the elements are processed. An object in the closure scope is returned at completion of the closure.

For example to extract all transactions from a user-specified date (syntax may be further refined) the following code snippet may be used; date=requestDateConstant(“specify date”, . . . ); dataArray=performQuery(“select date, description, amount from chequing”); result=dataArray.iterate(date) var matchingDate[ ]; {if this.date.equals(date) {matchingDate.add(this);}} returns matchingDate. Manipulating fields may be performed as in the example using miscCategory=requestStringConstant(“miscellaneous category”, . . . ); result=dataArray.iterate(miscCategory) {if !this.hasField(“category”) {this.addField(“category”, miscCategory);}} returns this.

General object services are methods available that application developers would expect, with the added restriction contents of strings cannot be deduced from the operations. All operations on objects are performed using other remote objects, for example, the code fragment i=string.indexOf(otherString) is acceptable but the code fragment i=string.indexOf(“string”) is illegal. Similarly, there is no possibility to determine a value of a Number; the number can only be compared to other numbers. String data type has operations including -compareTo [lessThan, greaterThan, equals]-indexOftotherString) -substring(numberHandle) -contains(otherString) -lastIndexOf(otherString) -toNumber -toDate -isValid [true unless an invalid string is created through a failed ‘toString’ conversion service] . . . Number data type includes -compareTo [lessThan, greaterThan, equals] -toString -isValid [true unless an invalid string is created through a failed ‘toString’ conversion service] . . . and Date data type includes -compareTo [lessThan, greaterThan, equals] -getMonth -getDay -getYear -isValid [true unless an invalid string is created through a failed ‘to String’ conversion service] . . . .

Responsive to a determination that the tokenized data is not to be modified, process 500 skips to perform step 518. Process 500 determines whether more requests exist for the untrusted third party application (step 518). Responsive to a determination that more requests exist for the untrusted third party application, process 500 loops back to perform step 506 as before. Responsive to a determination that more requests do not exist for the untrusted third party application, process 500 requests the trusted server to send results to a requester (step 520). Process 500 using the trusted server sends results to the requester (step 522) and terminates thereafter (step 524). Sending the results from the trusted server to the requester for display further comprises including formatting information provided by the untrusted third party application, replacing the tokenized data with corresponding unsecure data and combining the corresponding unsecure data with the formatting information.

As with input, results of the operations are written through trusted server-provided services. For example a basic service is provided as in a code snippet of writeObjectToTable(“title”, “field 1”, “field 2”, “field 3”, . . . , “fieldN”, object); where title is the title of the table, and field 1, field 2, field 3, through fieldN are fields to write out, in order and object is an object handle referencing the data. When the object is an array, each element of the array is a row of the table. Other formats for displaying data, for example, pie charts, bar charts and other chart types are provided and more control over displaying the data for example, use of colors of cells, borders, and other eye catcher techniques. The untrusted third party application provides the formatting information and template while the trusted server provides the real unsecure data for the display fields directly to the user or requester preventing the untrusted third party application from handling the real or secure data.

In an alternative embodiment a request from a user may be received at an untrusted third party application and forwarded to a trusted server. The user request may not contain any unsecure data however. The trusted server would invoke transactions on a secure data store and provide tokenized data to the untrusted third party application as before. The requester would perceive all transactions as being processed on the trusted server as in the previous illustrative embodiment.

Thus is provided in one illustrative embodiment a computer-implemented process for delegating access to private data receives a request at a trusted server, forwards the received request to an untrusted third party application and invokes a transaction on a secure data store. The computer-implemented process further tokenizes data received from the secure data store by the trusted server, returns the tokenized data to the untrusted third party application, modifies the tokenized data by the untrusted third party application, requests the trusted server to send results to a requester and sends the results from the trusted server to the requester for display.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented process for delegating access to private data, the computer-implemented process comprising:
receiving a request at a trusted server;
forwarding the received request to an untrusted third party application;
invoking a transaction on a secure data store;
tokenizing data received from the secure data store by the trusted server;
returning the tokenized data to the untrusted third party application;
modifying the tokenized data by the untrusted third party application;
requesting the trusted server to send results to a requester; and
sending the results from the trusted server to the requester for display.

2. The computer-implemented process of claim 1 wherein forwarding the received request to an untrusted third party application further comprises:
sending an identifier associated with a requester, wherein the identifier is known to the trusted server.

3. The computer-implemented process of claim 1 wherein invoking a transaction on a secure data store further comprises:
using trusted application programming interfaces associated with the trusted server, wherein the trusted application programming interfaces function with tokenized data and prevent the untrusted third party application from accessing unsecure data.

4. The computer-implemented process of claim 1 wherein tokenizing data received from the secure data store by the trusted server further comprises:
providing an opaque handle representative of the secure data.

5. The computer-implemented process of claim 1 wherein modifying the tokenized data further comprises:
determining whether to modify the tokenized data using trusted application programming interfaces; and
responsive to a determination not to modify the tokenized data, determining whether more requests exist for the untrusted third party application.

6. The computer-implemented process of claim 1 wherein requesting the trusted server to send results to a requester further comprises:
determining whether more requests exist for the untrusted third party application; and
responsive to a determination more requests exist, forwarding the received request to the untrusted third party application.

7. The computer-implemented process of claim 1 wherein sending the results from the trusted server to the requester for display further comprises:
including formatting information provided by the untrusted third party application;
replacing the tokenized data with corresponding unsecure data; and
combining the corresponding unsecure data with the formatting information.

8. A computer program product for delegating access to private data, the computer program product comprising:
a computer recordable-type media containing computer executable program code stored thereon, the computer executable program code comprising:
computer executable program code for receiving a request at a trusted server;
computer executable program code for forwarding the received request to an untrusted third party application;
computer executable program code for invoking a transaction on a secure data store;
computer executable program code for tokenizing data received from the secure data store by the trusted server;
computer executable program code for returning the tokenized data to the untrusted third party application;
computer executable program code for modifying the tokenized data by the untrusted third party application;
computer executable program code for requesting the trusted server to send results to a requester; and
computer executable program code for sending the results from the trusted server to the requester for display.

9. The computer program product of claim 8 wherein computer executable program code for forwarding the received request to an untrusted third party application further comprises:
computer executable program code for sending an identifier associated with a requester, wherein the identifier is known to the trusted server.

10. The computer program product of claim 8 wherein computer executable program code for invoking a transaction on a secure data store further comprises:
computer executable program code for using trusted application programming interfaces associated with the trusted server, wherein the trusted application programming interfaces function with tokenized data and prevent the untrusted third party application from accessing unsecure data.

11. The computer program product of claim 8 wherein computer executable program code for tokenizing data received from the secure data store by the trusted server further comprises:
computer executable program code for providing an opaque handle representative of the secure data.

12. The computer program product of claim 8 wherein computer executable program code for modifying the tokenized data further comprises:
computer executable program code for determining whether to modify the tokenized data using trusted application programming interfaces; and
computer executable program code responsive to a determination not to modify the tokenized data, for determining whether more requests exist for the untrusted third party application.

13. The computer program product of claim 8 wherein computer executable program code for requesting the trusted server to send results to a requester further comprises:
computer executable program code for determining whether more requests exist for the untrusted third party application; and
computer executable program code responsive to a determination more requests exist, for forwarding the received request to the untrusted third party application.

14. The computer program product of claim 8 wherein computer executable program code for sending the results from the trusted server to the requester for display further comprises:
computer executable program code for including formatting information provided by the untrusted third party application;
computer executable program code for replacing the tokenized data with corresponding unsecure data; and
computer executable program code for combining the corresponding unsecure data with the formatting information.

15. An apparatus for delegating access to private data, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receive a request at a trusted server;
forward the received request to an untrusted third party application;
invoke a transaction on a secure data store;
tokenize data received from the secure data store by the trusted server;
return the tokenized data to the untrusted third party application;
modify the tokenized data by the untrusted third party application;
request the trusted server to send results to a requester; and
send the results from the trusted server to the requester for display.

16. The apparatus of claim 15 wherein the processor unit executes the computer executable program code to forward the received request to an untrusted third party application further directs the apparatus to:
send an identifier associated with a requester, wherein the identifier is known to the trusted server.

17. The apparatus of claim 15 wherein the processor unit executes the computer executable program code to invoke a transaction on a secure data store further directs the apparatus to:
use trusted application programming interfaces associated with the trusted server, wherein the trusted application programming interfaces function with tokenized data and prevent the untrusted third party application from accessing unsecure data.

18. The apparatus of claim 15 wherein the processor unit executes the computer executable program code to tokenize data received from the secure data store by the trusted server further directs the apparatus to:
provide an opaque handle representative of the secure data.

19. The apparatus of claim 15 wherein the processor unit executes the computer executable program code to modify the tokenized data further directs the apparatus to:
determine whether to modify the tokenized data using trusted application programming interfaces; and
responsive to a determination not to modify the tokenized data, determine whether more requests exist for the untrusted third party application.

20. The apparatus of claim 15 wherein the processor unit executes the computer executable program code to send the results from the trusted server to the requester for display further directs the apparatus to:
include formatting information provided by the untrusted third party application;
replace the tokenized data with corresponding unsecure data; and
combine the corresponding unsecure data with the formatting information.
